(19) United States
(12) Patent Application Publication
(10) Pub. No.: US 2006/0256234 A1
(43) Pub. Date: Nov. 16, 2006

(54) Method and apparatus for encoding a motion signal with a sound signal

(76) Inventors: Philippe Roy, St-Bruno (CA); Bruno Paillard, Sherbrooke (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/411,147

(22) Filed: Apr. 26, 2006

Related U.S. Application Data
(60) Provisional application No. 60/674,695, filed on Apr. 26, 2005.

(51) Int. Cl. H04N 11/02

(52) U.S. Cl. 348/407.1

(57) ABSTRACT

A method for encoding a motion signal with a sound signal. The method comprises providing a motion signal, providing a sound signal, encoding the motion signal with the sound signal to generate a synchronized composite audio/motion signal and providing the synchronized composite audio/motion signal.

### CROSS-REFERENCE TO RELATED APPLICATIONS

This patent application claims priority of U.S. provisional Patent Application No 60/674,695, entitled “Method and apparatus for encoding a motion signal with a sound signal” that was filed Apr. 26, 2005, the specification of which is hereby incorporated by reference.

### TECHNICAL FIELD

This invention pertains to the field of entertainment motion devices. In particular, this invention pertains to encoding a motion signal with a sound signal.

### BACKGROUND OF THE INVENTION

Motion signals are used to drive actuators in order to deliver motion to thereby create reciprocate movements preferably synchronized with a sound signal track and or a video track. Unfortunately, prior art devices require a specific and dedicated medium for storing the motion signals.

The skilled addressee will appreciate that this is quite cumbersome as it requires a user to have a dedicated medium for storing a motion signal as well as a dedicated medium for storing at least one of the audio/video track.

Furthermore, it will be appreciated that a user using an audio/video track encoded using a first given standard or algorithm might be prevented from using the medium storing the motion signal as the latter may have been created to be supported to use an audio/video track encoded using a second given standard or algorithm. Such drawback is major and requires that users carefully check what type of standard is used for encoding the audio/video track. This therefore de facto limits the wide spread use of motion signals in a market where various standards or algorithms are used to encode the audio/video track.

It will further be appreciated that synchronization may also be an issue.

In view of the above, there is a need for a method and apparatus that will overcome at least one of the above-identified drawbacks.

### SUMMARY OF THE INVENTION

According to an aspect of the invention, there is provided a method for encoding a motion signal with a sound signal. The method comprises providing a motion signal, providing a sound signal, encoding the motion signal with the sound signal to generate a synchronized composite audio/motion signal and providing the synchronized composite audio/motion signal.

An apparatus for providing a synchronized composite audio/motion signal, the apparatus comprising a motion signal providing unit for providing a motion signal, a sound signal providing unit for providing a sound signal, a synchronizing unit receiving the provided motion signal and the sound signal and generating the synchronized composite audio/motion signal.

### BRIEF DESCRIPTION OF THE DRAWINGS

Further features and advantages of the present invention will become apparent from the following detailed description, taken in combination with the appended drawings, in which:

FIG. 1 is a block diagram which shows an embodiment of an apparatus for encoding a motion signal with a sound signal according to an embodiment of the invention. The apparatus comprises a motion signal providing unit, a sound signal providing unit, an encoding algorithm providing unit, an encoding unit and an encoded bitstream signal providing unit;

FIG. 2 is a block diagram which shows an embodiment of the encoding unit according to an embodiment of the invention;

FIG. 3 is a flowchart which shows how a synchronized composite audio/motion signal is provided according to an embodiment of the invention. According to one step, the motion signal is encoded using an encoding algorithm to provide a synchronized composite audio/motion signal; and

FIG. 4 is flowchart which shows how the motion signal is encoded using an encoding algorithm to provide a synchronized composite audio/motion signal.

It will be noted that throughout the appended drawings, like features are identified by like reference numerals.

### DETAILED DESCRIPTION

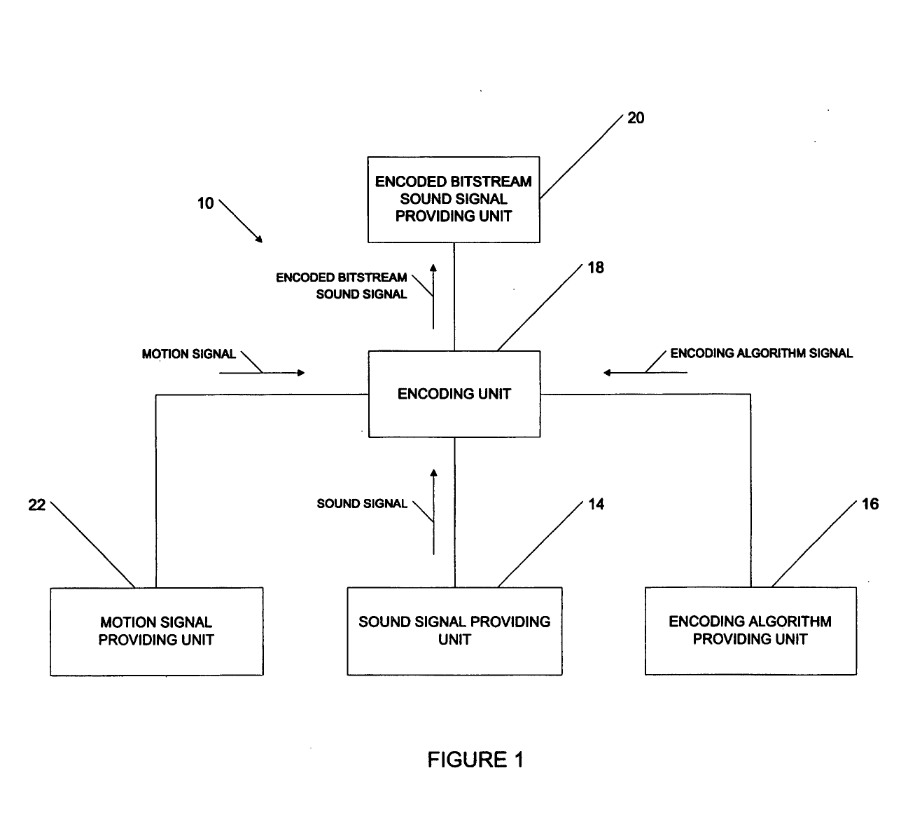

Now referring to FIG. 1, there is shown an embodiment of an apparatus 10 for encoding a motion signal with a sound signal.

More precisely, the apparatus 10 comprises a motion signal providing unit 12, a sound signal providing unit 14, a synchronizing unit, an example of which comprises an encoding algorithm providing unit 16 and an encoding unit 18, and finally a composite audio/motion signal providing unit 20.

The motion signal providing unit 12 is adapted to provide a motion signal. It will be appreciated by the skilled addressee that the motion signal may be used by a plurality of actuators in order to provide reciprocate movements to the user.

In an embodiment, the motion signal providing unit 12 comprises a storing medium comprising a motion signal which has been programmed to be played with a corresponding sound signal of a given video signal. In an embodiment, the storing medium of the motion signal providing unit may be a hard disk, a CD, a DVD or the like.

The sound signal providing unit 14 is adapted to provide a sound signal with which the motion signal has to be played. It will be appreciated by the skilled addressee that the sound signal may be synchronized with a video signal, not shown in FIG. 1. It will be further appreciated that the sound signal providing unit may provide a sound signal that has already been encoded as well as a sound signal that has not been encoded (i.e., raw sound data). In an embodiment, the sound signal providing unit is a sound file located on a storing medium such as a hard disk, a CD, a DVD or the like.

The encoding algorithm providing unit 16 is adapted to provide an encoding algorithm for encoding the motion with the sound signal. The encoding algorithm may be any algorithm which allows the insertion of the motion signal into a composite audio/motion signal, and which allows its extraction at the time of the play-back. Algorithms which in addition provide a compression of the audio/motion composite signal in order to reduce the number of bits required to represent it, while minimizing the detectability of the bit rate reduction to the senses of the user may be applied or not.

The encoding unit 18 is adapted to receive a motion signal, a sound signal and an encoding algorithm. The encoding unit 18 is further adapted to encode the motion signal in the sound signal according to the encoding algorithm to generate an encoded sound signal. It will be appreciated by the skilled addressee that the encoding unit 18 may be any processing unit suitable for performing such task. In an embodiment, the encoding unit 18 is an application running on a computer. Alternatively, the encoding unit 18 implemented in hardware/firmware (such as for instance in a DSP (Digital Signal Processor) or in an FPGA (Field Programmable Gate Array)).

The composite audio/motion signal providing unit 20 is adapted to provide the composite audio/motion signal to a user. More precisely, the composite audio/motion signal providing unit 20 may be any one of a memory, a storing medium for storing data such as a DVD ROM, a CD ROM or the like, a communication unit for transmitting the composite audio/motion signal to a plurality of users, or the like.

In an embodiment, the composite audio/motion signal providing unit 20 is a computer used to generate the composite audio/motion signal, a DVD burner, a DVD manufacturing plant. Alternatively, the composite audio/motion signal providing unit 20 may be a communication unit adapted to provide the composite audio/motion signal to a plurality of users. For instance, it will be appreciated that the communication unit may be adapted to provide the composite audio/motion signal over a network which may be wireless, such as a television network, or wired such as a local area network (LAN), a metropolitan area network (MAN) or a wide area network (WAN) such as the Internet.

More precisely, the motion signal providing unit 12 provides a motion signal to the encoding unit 18. The sound signal providing unit 14 provides a sound signal to the encoding 18 and the encoding algorithm providing unit 16 provides an encoding algorithm to the encoding unit 18.

The encoding unit 18 encodes the motion signal with the bitstream sound signal according to the provided encoding algorithm. The resulting composite audio/motion signal is provided by the encoding unit 18 to the composite audio/motion signal providing unit 20.

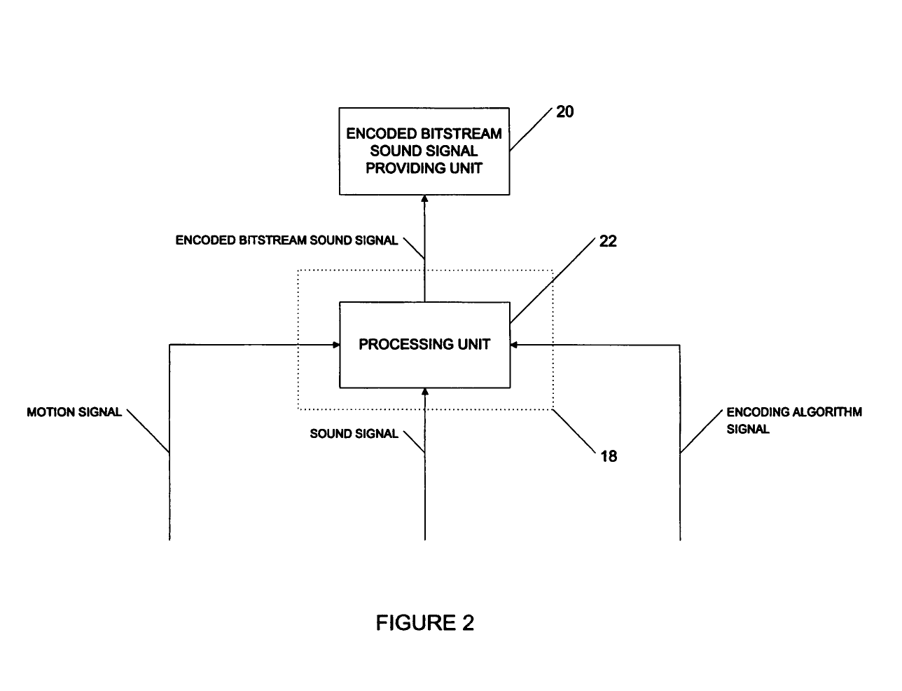

Now referring to FIG. 2, there is shown an embodiment of the apparatus 10, shown in FIG. 1, wherein the encoding unit 18 comprises a processing unit 22. The skilled addressee will appreciate that some devices, such as a memory unit, have not been disclosed in FIG. 2, for clarity sake.

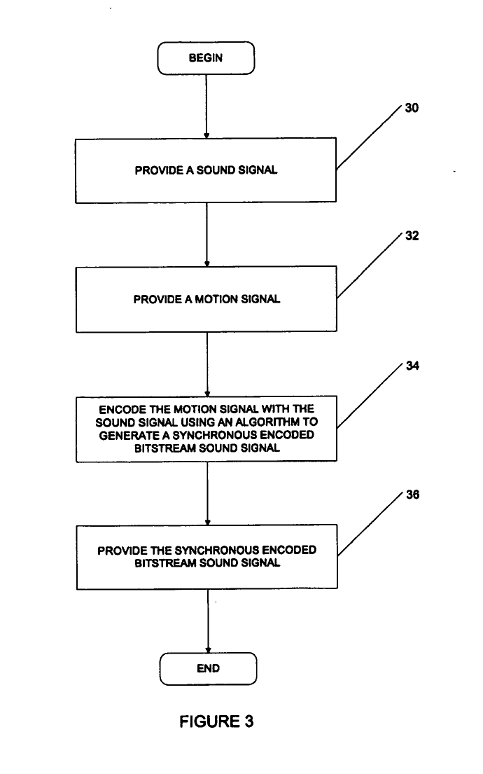

Now referring to FIG. 3, there is shown an embodiment of the method for providing a synchronized composite audio/motion signal according to an embodiment.

According to step 30, a sound signal is provided. The sound signal is provided by the sound signal providing unit 14.

According to step 32, a motion signal is provided. The motion signal is provided by the motion signal providing unit 12.

According to step 34, the provided motion signal is encoded with the provided sound signal using an encoding algorithm to provide a synchronized composite audio/motion signal. In an embodiment, the encoded composite audio/motion signal is created following the existing standard for creating the audio bitstream on a DVD. This way, the composite audio/motion signal may be played onto an existing and commercially available DVD player, and will be available on the available SPDIF output of existing players. The skilled addressee will appreciate that this is of great advantage as it enables the user to keep his DVD player. The user has only to add a composite audio/motion decoder connected to the existing SPDIF output of the DVD player. The output of the composite audio/motion signal decoder is then sent to a motion controller such as the D-Box® Kinetron™ controller (not shown).

In another embodiment (not shown), a composite audio/motion signal decoder and a motion controller are incorporated in DVD players in hardware, software or firmware. This way, a separate motion controller would not be necessary.

In an embodiment, this encoding is performed by the encoding unit 18.

According to step 36, the synchronized composite audio/motion signal is provided. The synchronized composite audio/motion signal is provided to the composite audio/motion signal providing unit 20.

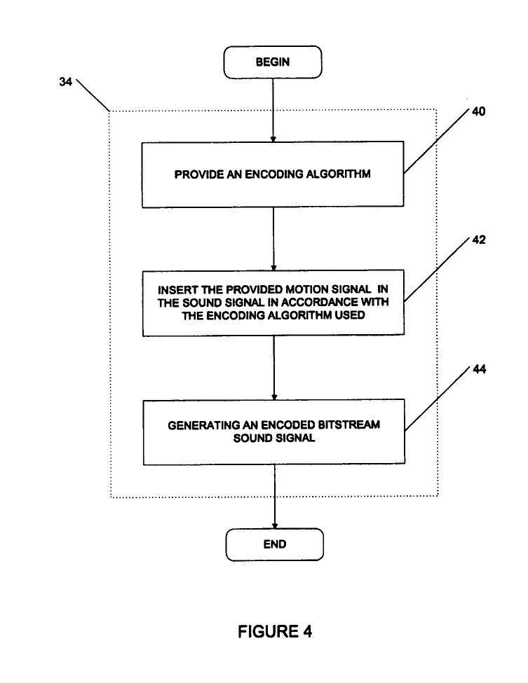

Now referring to FIG. 4, there is shown an embodiment of how the motion signal is encoded with the sound signal using the encoding algorithm.

According to step 40, an encoding algorithm is provided. As explained earlier the encoding algorithm is provided by the encoding algorithm providing unit 16.

Examples of such encoding algorithms are those which are compatible with the IEC61937 standard, an example of which are the AC3 standard of Dolby™ and DTS encoding algorithms. The AC3 encoding algorithm is further described in “ATSC Standard: Digital Audio Compression (AC3), Revision A, Doc A/52A (20 Aug. 2001)”, published by Advanced Television Systems Committee, 1750 K Street, N.W., suite 1200, Washington D.C. 20006, which is hereby incorporated by reference.

According to step 42, the provided motion signal is inserted in the provided sound signal in accordance with the encoding algorithm used. Such inserting is performed using the encoding unit 18.

According to step 44, a composite audio/motion signal is generated.

It should be appreciated by the skilled addressee that the composite audio/motion signal may further be decoded in accordance with the algorithm used to encode the motion signal with the sound signal.

The skilled addressee will further appreciate that the encoding is performed such that the encoded sound signal is synchronized with the motion signal. It has been contemplated that providing an encoded sound signal synchronized with the motion signal is of great advantage as it enables a synchronous delivering of the motion signal which is desirable. It has been contemplated that a first advantage of the method disclosed is the fact that it frees that a motion player from having to store a motion signal prior to playback, therefore greatly reducing its memory resources. A second advantage of the method disclosed is that it frees the motion player from having required computational resources for re-synchronizing the motion signal to the audio signal, therefore greatly reducing its computational resources.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetical signal.

The embodiments of the invention described above are intended to be exemplary only. The scope of the invention is therefore intended to be limited solely by the scope of the appended claims.

We claim:

1. A method for encoding a motion signal with a sound signal, said method comprising:
providing a motion signal;
providing a sound signal;
encoding the motion signal with the sound signal to generate a synchronized composite audio/motion signal; and
providing the synchronized composite audio/motion signal.

2. The method as claimed in claim 1, wherein said encoding of said motion signal with the sound signal comprises providing an encoding algorithm and inserting the provided motion signal in the sound signal in accordance with the provided encoding algorithm.

3. The method as claimed in claim 2, wherein said encoding algorithm is compatible with the IEC61937 standard.

4. The method as claimed in claim 3, wherein said encoding algorithm comprises at least one of AC3 and DTS.

5. The method as claimed in claim 1, wherein said motion signal is provided using a storing medium.

6. The method as claimed in claim 5, wherein said storing medium is selected from a group consisting of hard disk, flash memory, Compact Disk, Digital Video Disk (DVD).

7. The method as claimed in claim 1, wherein said synchronized composite audio/motion signal is provided over a network.

8. An apparatus for providing a synchronized composite audio/motion signal, said apparatus comprising:
a motion signal providing unit for providing a motion signal;
a sound signal providing unit for providing a sound signal;
a synchronizing unit receiving said provided motion signal and said sound signal and generating said synchronized composite audio/motion signal.

9. The apparatus as claimed in claim 8, wherein said synchronizing unit comprises an encoding algorithm providing unit for providing an encoding algorithm and an encoding unit receiving said provided motion signal, said sound signal and said encoding algorithm and inserting the provided motion signal in the sound signal in accordance with the provided encoding algorithm to provide said synchronized composite audio/motion signal.

10. The apparatus as claimed in claim 8, wherein said encoding algorithm is compatible with the IEC61937 standard.

11. The apparatus as claimed in claim 10, wherein said encoding algorithm comprises at least one of AC3 and DTS.

12. The apparatus as claimed in claim 8, wherein said motion signal providing unit comprises a storing medium comprising said motion signal.

13. The apparatus as claimed in claim 12, wherein said storing medium is selected from a group consisting of hard disk, flash memory, Compact Disk, Digital Video Disk (DVD).

14. The apparatus as claimed in claim 8, wherein said sound signal providing unit provides one of a raw sound signal and an already encoded sound signal.

15. The apparatus as claimed in claim 8, wherein said encoding unit comprises one of a Digital Signal Processor (DSP) and a Field Programmable Gate Array (FPGA).

16. A computer readable memory adapted to store instructions which when executed create the method claimed in claim 1.
